(19) United States
(12) Patent Application Publication
(10) Pub. No.: US 2025/0117537 A1
(43) Pub. Date: Apr. 10, 2025

(54) Method and System for Interactive Explanations in Industrial Artificial Intelligence Systems

(71) Applicant: ABB Schweiz AG, Baden (CH)

(72) Inventors: Joakim Astrom, Solna (SE); Divyasheel Sharma, Bangalore (IN); Yemao Man, Solna (SE); Gayathri Gopalakrishnan, Eskilstuna (SE); Benjamin Kloepper, Mannheim (DE); Dawid Ziobro, Västerås (SE); Benedikt Schmidt, Heidelberg (DE); Arzam Muzaffar Kotriwala, Ladenburg (DE); Marcel Dix, Allensbach (DE)

(73) Assignee: ABB Schweiz AG, Baden (CH)

(21) Appl. No.: 18/929,853

(22) Filed: Oct. 29, 2024

Related U.S. Application Data
(63) Continuation of application No. PCT/EP2022/061589, filed on Apr. 29, 2022.

(51) Int. Cl. G06F 30/18; G06F 30/27; G06F 113/14

(52) U.S. Cl. CPC G06F 30/18; G06F 30/27; G06F 2113/14

(57) ABSTRACT

A method for interactive explanations in industrial artificial intelligence systems includes providing a machine learning model and a set of test data, a set of training data and a set of historical data simulating a piping and process equipment; predicting a result for the piping and process equipment based on the machine learning model using the set of test data and the set of training data, wherein the set of historical data is used by the machine learning model to predict at least one parameter of the piping and process equipment; and presenting the predicted at least one parameter on a piping and instrumentation diagram of the piping and process equipment.

### CROSS-REFERENCE TO RELATED APPLICATIONS

The instant application claims priority to International Patent Application No. PCT/EP2022/061589, filed Apr. 29, 2022, which is incorporated herein in its entirety by reference.

### FIELD OF THE DISCLOSURE

The present disclosure relates to a method and a system for interactive explanations in industrial artificial intelligence systems.

### BACKGROUND OF THE INVENTION

The general background of this disclosure is interactive machine learning, ML, in the form of for instance active learning, explanatory learning, or visual interactive labeling are a good way to acquire labels for supervised machine learning models.

Explanations in machine learning systems are commonly static and do now allow users to interact with the explanations provided. This may make it harder for users to understand the underlying factors for provided explanations and could make it hard for the user to fully utilize explanations, possibly leading to misunderstandings and causing a negative perception of the system.

Current explanations in industrial process systems are commonly static and may not contain or present data that is understandable or relevant for all users. This may make users frustrated or, in worse cases, make them take bad or even dangerous decisions. A proposed solution to these problems is usually to increase system transparency. However, increasing transparency can mean several different things depending on factors such as context or type of user. A further problem is that users are unable to question or add new information to explanations presented, posing a risk of making the quality and accuracy of explanations be perceived as low, while also risking further decline in quality over time. Static explanations may also be perceived as unhelpful or irritating, given that users may not be interested in or understand the information presented.

### BRIEF SUMMARY OF THE INVENTION

The present disclosure proposes a solution where users are presented with explanations through a cause-and-effect diagram for the predicted anomaly or for any fault diagnosis or for any predicted parameter of the piping and process equipment, which they can choose to investigate further by comparing and replaying historical time-series data that matches the current situation. They can further explore and tailor the explanation by adding or removing parameters that were used to make the prediction, which can then be sent to a simulator to see the effect that this has on the predicted anomaly or on any fault diagnosis or on any predicted parameter. Scenarios which are deemed to better explain the current anomaly can be annotated and sent for integration into the machine learning model.

In one aspect, a method for interactive explanations in industrial artificial intelligence systems is described, the method comprising: providing a machine learning model and a set of test data, a set of training data and a set of historical data simulating a piping and process equipment; predicting a result for the piping and process equipment based on the machine learning model using the set of test data and the set of training data, wherein the set of historical data is used by the machine learning model to predict at least one parameter of the piping and process equipment; and presenting the predicted at least one parameter on a piping and instrumentation diagram of the piping and process equipment.

The at least one parameter of the piping and process equipment may include anomalies of the piping and process equipment or any fault detection or diagnosis of the piping and process equipment.

The intuition of the present invention is to help users understand and make use of explanations, we propose to make explanations more interactive. This is done by presenting the explanation in different formats while allowing the user to decide how much information they want to see. By presenting the predicted at least one parameter for example in the cause-and-effect diagram which shows the possible interactions that could be the underlying reasons for the predicted anomaly, the user can confirm or deny their current belief about the prediction.

The historical data onto which the prediction is based on can also be reviewed and compared or replayed, to help the user determine if they think the prediction is believable or not. They can also use these replays to explore possible outcomes and see what effect previously applied solutions had. If the user wants to explore further, want to test alternative solutions or if the user has information that the system is currently lacking, they can add or remove data from the current prediction and run it again with new parameters in a simulated environment. This can help the user determine the relevance of the parameters used by the system to make the prediction, where any relevant additions to the scenario may be annotated and sent for integration into the model. Integrating this end-user data into the model helps it stay relevant and updated over longer periods of time. The progressive disclosure of information gives the user larger agency over explanations provided, which affords a sense of control and exploration when interacting with the system.

The embodiments in accordance with the disclosure alter the traditional machine learning loop in the sense that historical data is used to make the predictions of upcoming anomalies, where the user's experimental scenarios can be added to the training data and used to update and maintain the model.

### BRIEF DESCRIPTION OF THE SEVERAL VIEWS OF THE DRAWING(S)

FIG. 1 is a diagram of a traditional machine learning process for explainable artificial intelligence (AI) in accordance with the disclosure.

FIG. 2 is a diagram of an altered machine learning loop in accordance with the disclosure.

FIG. 3 is a flowchart for a method for interactive explanations in industrial artificial intelligence systems in accordance with the disclosure.

FIG. 4 is a functional block diagram of basic system interaction in accordance with the disclosure.

FIG. 5 is a cause-and-effect diagram in accordance with the disclosure.

FIG. 6 is a time table in accordance with the disclosure.

FIG. 7 is a time table in accordance with the disclosure.

### DETAILED DESCRIPTION OF THE INVENTION

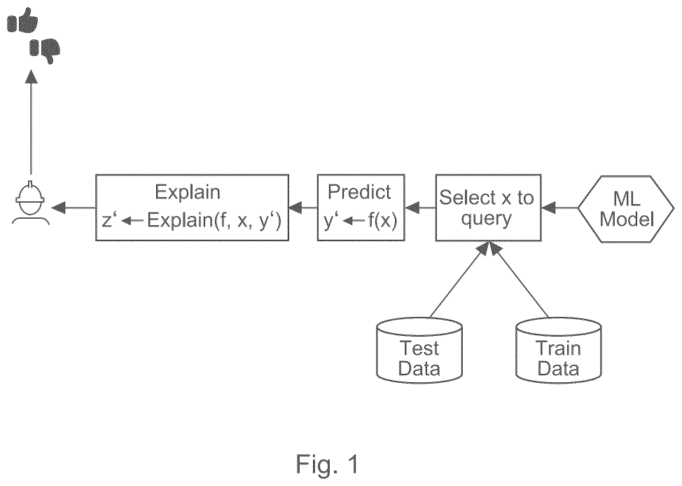

The following embodiments are mere examples for the method and the system disclosed herein and shall not be considered limiting. FIG. 1 illustrates a traditional machine learning process for explainable AI.

A system and a method are described herein, which help users explore and understand explanations given in an industrial process context. By presenting the predicted at least one parameter for example in terms of predicted anomalies visually directly on the piping and instrumentation diagram the piping and process equipment and any fault is represented, while also allowing the user to manually investigate the parameters on which the prediction is based in, a transparent system is provided that allow users to engage in various degrees of exploration.

The user can experiment with the presented explanation, where time series data from the current prediction can be compared with historical data of similar situations. According to an exemplary embodiment of the present invention, the historical data can be replayed to explore the previous outcomes and actions of similar situations.

In addition to this, the user can use a simulator to select, add or remove data used for the prediction, which allows the user to explore alternative outcomes through simulation. This incentivizes the user to provide data explicitly by giving them a sense of control and exploration while providing corrections by annotating and integrating corrected scenarios as new predictive data for the model.

According to an exemplary embodiment of the present disclosure, interactive explanations based on simulations are given. According to an exemplary embodiment of the present invention, searchable and/or re-playable historical data as explanation are provided. Further, editable time series data used to explore and correct explanations might be included or a set of simulation-based scenarios as input for ML model improvement.

According to an exemplary embodiment of the present invention, a system or a method that allows end-users to review and manipulate explanations is provided.

According to an exemplary embodiment of the present invention, a system or a method that allow simulations based on historical data and user input is provided.

According to an exemplary embodiment of the present invention, a system or a method that allows users to explore explanations through simulation is provided.

According to an exemplary embodiment of the present invention, a system or a method that allows users to annotate end-user feedback scenarios for machine learning model integration is provided.

According to an exemplary embodiment of the present invention, a system or a method that allows users to search and replay historical scenarios is provided.

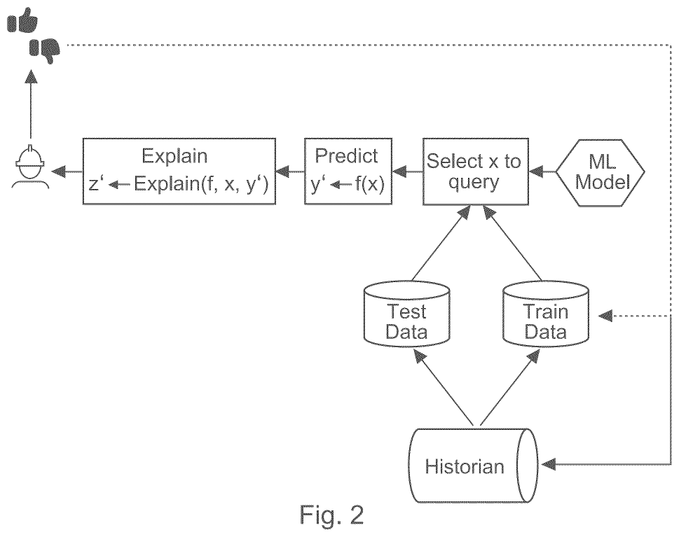

FIG. 2 illustrates an altered machine learning loop for the proposed invention.

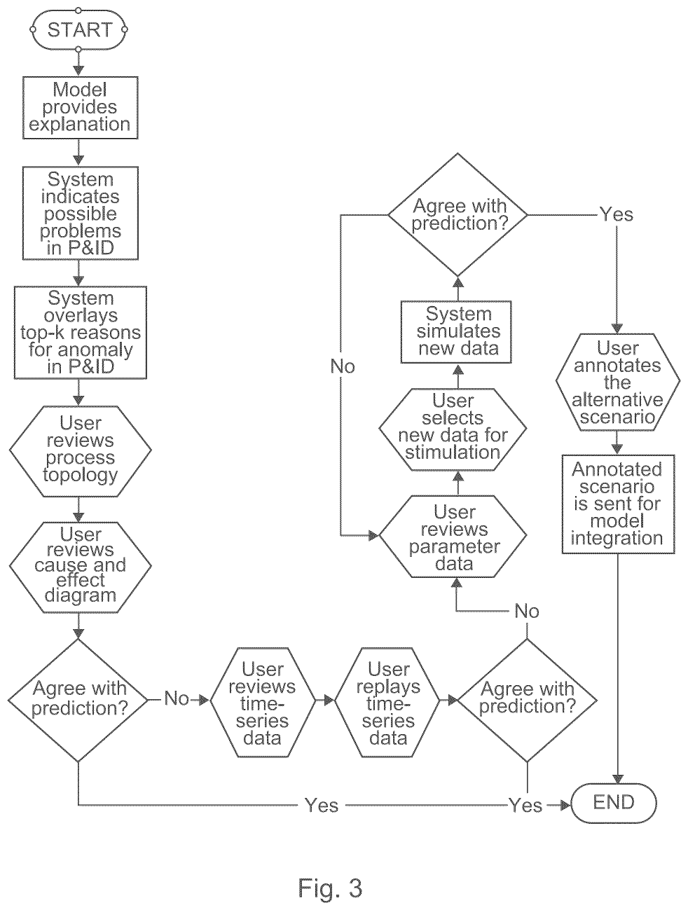

FIG. 3 illustrates an example of the method for interactive explanations in industrial artificial intelligence systems.

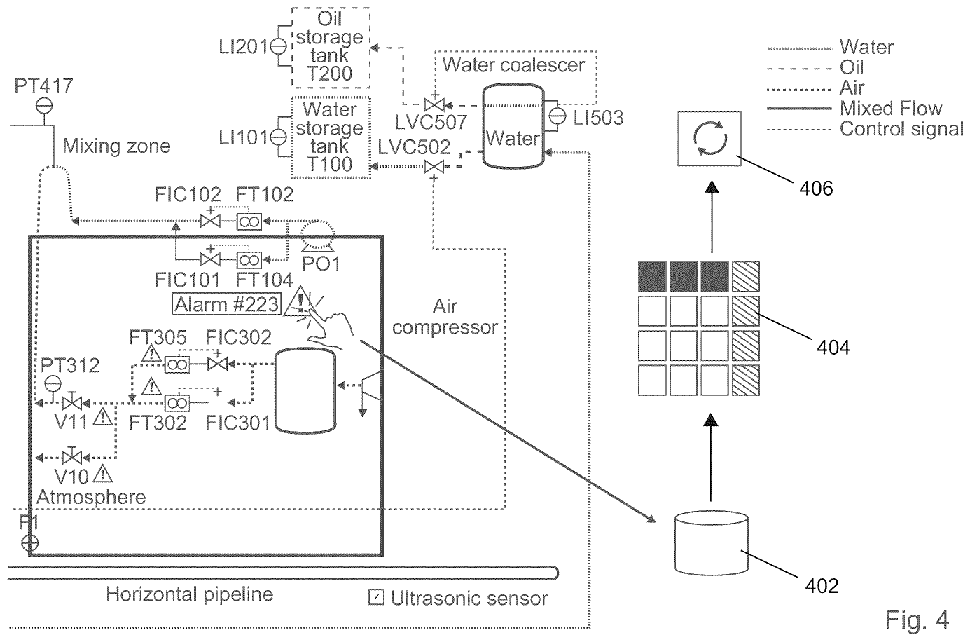

FIG. 4 illustrates the basic system interaction; the idea is based on the premise that users should have agency over the explanations presented to them during interactions with an industrial system. The idea outlined in this proposal is based on system anomaly prediction and prevention, where the concept introduced allows a user to review, manipulate and simulate parameters when an anomaly has been predicted in an industrial process flow. Even though the idea is outlined on system “anomaly” prediction it is applicable to any ML-based prediction including fault detection and diagnosis in an industrial context.

The suggested method and system allow the user to interact with different layers of explanations in stages, which makes for an experience that is adjustable based on the user's expertise and role in the current situation.

During the first step of this process, the system predicts a possible anomaly based on historical data, where similar situations have been proven to cause errors previously. The predicted anomaly is indicated in the piping and instrumentation diagram, P&ID, through a warning sign. The system also outlines the possible factors causing this anomaly to happen on the P&ID. As an example, if the prediction says that the anomaly will happen in the air compressor, then the system will highlight possible errors in the pressure tanks or ventilators connecting to this compressor, given that they have caused similar anomalies in similar, previous scenarios.

This information is presented to the user in the form of an alarm, where the system provides a simple natural language explanation, which for example could state that there has been a rapid decline in pressure. The system overlays the top-k reasons for this malfunction on the P&ID, which may also include issues with the nearby ventilators or the second nearby pressure tank. In addition to this process topology overlay, the system provides a cause-and-effect diagram which the user can review to better understand the possible correlation between the anomaly and the possible reasons for it.

The user is able to get an overview of the possible reasons for the anomaly or fault detection and diagnosis through the process topology or gain more detailed insights by reviewing the cause-and-effect diagram. The system presents the top reasons for the prediction at the top of the cause-and-effect diagram, but this diagram can also be used to see other possible interactions that may have had an effect of the current state of the system.

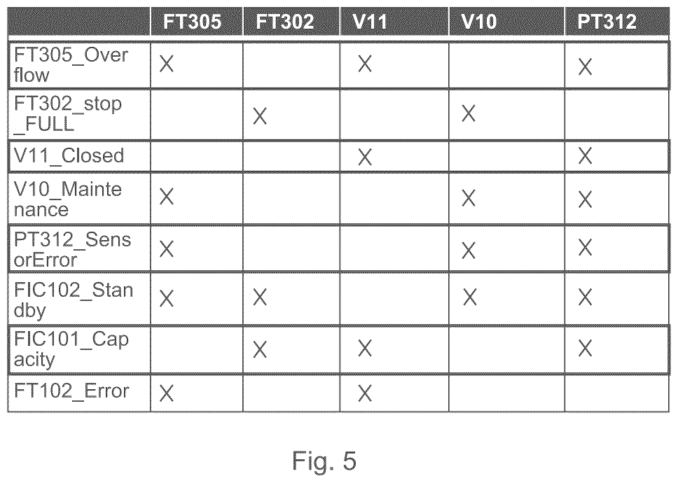

FIG. 5 shows the basic cause-and-effect diagram displaying which part of the system that may be affected by the status of various equipment. Users can filter among status and equipment to see other possible interactions between less probable causes.

After reviewing the presented explanations, the user can choose whether they want to dismiss the alarm or choose to inspect the predicted anomaly or any fault detection and diagnosis more closely. If the user chooses to proceed and inspect the prediction, relevant time-series data is presented to the user, where they can choose to extract the data that they believe is relevant for this situation. Time-series data is presented both in the form of a graph and a table.

The user can either mark a portion of the graph, to see similar trends or scenarios that have been recorded by the historian. They can then replay these previous scenarios, to help evaluate if they believe this to be an accurate and believable explanation to the current anomaly or current fault detection and diagnosis.

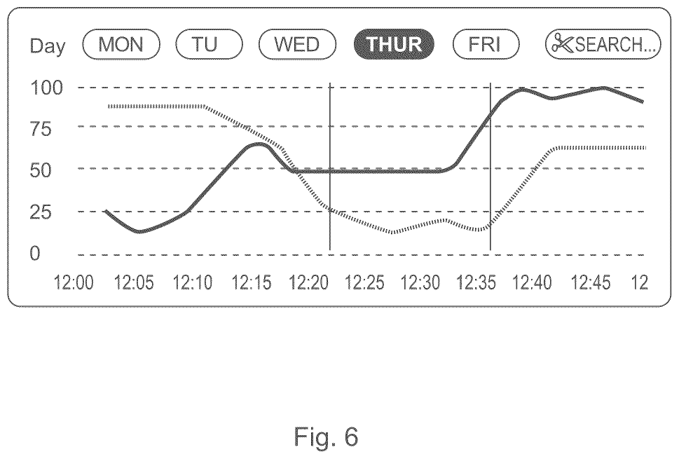

FIG. 6 shows a time table. The user can select which period of the time series data they want to look at. Previous similar scenarios can be reviewed and replayed to see past actions and outcomes.

If they do not agree with this explanation, or want to investigate the anomaly or the fault detection and diagnosis further, the user can also review the data as a table. Initially, the system presents the user with the top parameters that it believes to be the reasons for the predicted anomaly. In this table, the user is able to add or remove parameters, which are then sent to the system for simulation of new scenarios.

According to an exemplary embodiment of the present invention, the data presented in this table is stored in a databased or in an SQL database, where the user can interact with it by simple SQL commands such as “SELECT, FROM, WHERE”. This can be useful if the user has information about the anomaly that the system does not have, for example, the user could know that the ventilators were under maintenance last week and therefore are very unlikely to cause problems now, in contrast to what the historical data indicates.

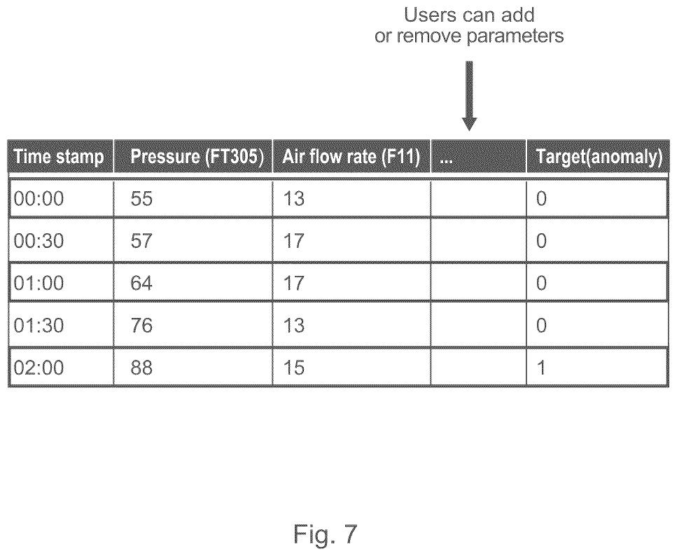

FIG. 7 shows a time table. The user can review the parameters possibly causing the issues leading to an anomaly. They can add new parameters or filter among current values to better understand what impact it might have on the prediction by running different scenarios in the simulator.

By interacting with this table, the user can simulate data in order to confirm or deny different hypotheses they have on what the reason for the anomaly is, as well as to try and deduce the root cause of the anomaly. As an example, the user might know that there is nothing wrong with the air flow in F11, since that was under maintenance last week, making the historical data less accurate and possibly misleading. They can then use the simulations to include or exclude parameters related to F11 and thereby try to deduce if the prediction is still correct and what would be causing the predicted issue in this alternative scenario.

The change would be shown as time series data in the form of a new table with updated values, along with an updated graph. The idea is that the user provides data explicitly in order to explore possible explanations to the problem, which can then be used as implicit training data for the model in cases where the user provides an alternative, correct explanation for the issue as when compared to the system's current explanation. If a user simulation provides a more probable explanation for a predicted anomaly, the user can annotate this alternative prediction with the changes they made to the parameters and send this alternative scenario for integration into the model.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

In an embodiment of the method for interactive explanations in industrial artificial intelligence systems, the set of test data and the set of training data is used to classify an experimental scenario of the piping and process equipment.

In an embodiment of the method for interactive explanations in industrial artificial intelligence systems, the method further comprises the step of providing interactive explanations based on the predicted result.

In an embodiment of the method for interactive explanations in industrial artificial intelligence systems, the method further comprises the step of providing searchable historical data as an explanation.

In an embodiment of the method for interactive explanations in industrial artificial intelligence systems, the method further comprises the step of providing replayable historical data as an explanation.

In an embodiment of the method for interactive explanations in industrial artificial intelligence systems, the method further comprises the step of providing editable time series data used to explore and correct explanations.

In an embodiment of the method for interactive explanations in industrial artificial intelligence systems, the method further comprises the step of providing simulation-based scenarios as input for an improvement of the machine learning model.

In an embodiment of the method for interactive explanations in industrial artificial intelligence systems, the method further comprises the step of providing an input data field for reviewing and/or manipulating of explanations as provided for the presented predicted anomalies.

In an embodiment of the method for interactive explanations in industrial artificial intelligence systems, the method further comprises the step of providing a machine learning model based on a set of data of a user input.

In an embodiment of the method for interactive explanations in industrial artificial intelligence systems, the method further comprises the step of an input data field for annotating end-user feedback scenarios for machine learning model integration.

In an embodiment of the method for interactive explanations in industrial artificial intelligence systems, the method further comprises the step of the step of that allowing a user to search and replay historical scenarios of the machine learning model.

In one aspect of the invention a system for interactive explanations in industrial artificial intelligence systems is presented, the system comprising a processor for executing the method according to the first aspect.

Any disclosure and embodiments described herein relate to the method and the system, lined out above and vice versa. Advantageously, the benefits provided by any of the embodiments and examples equally apply to all other embodiments and examples and vice versa.

As used herein “determining” also includes “initiating or causing to determine,” “generating” also includes “initiating or causing to generate” and “providing” also includes “initiating or causing to determine, generate, select, send or receive”. “Initiating or causing to perform an action” includes any processing signal that triggers a computing device to perform the respective action.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for interactive explanations in industrial artificial intelligence systems, the method comprising:
providing a machine learning model and a set of test data, a set of training data and a set of historical data simulating a piping and process equipment;
predicting a result for the piping and process equipment based on the machine learning model using the set of test data and the set of training data, wherein the set of historical data is used by the machine learning model to predict at least one parameter of the piping and process equipment; and
presenting the predicted at least one parameter on a piping and instrumentation diagram of the piping and process equipment.

2. The method according to claim 1, wherein the set of test data and the set of training data is used to classify an experimental scenario of the piping and process equipment.

3. The method according to claim 1, further comprising providing interactive explanations based on the predicted result.

4. The method according to claim 1, further comprising providing searchable historical data as an explanation.

5. The method according to claim 1, further comprising providing re-playable historical data as an explanation.

6. The method according to claim 1, further comprising providing editable time series data used to explore and correct explanations.

7. The method according to claim 1, further comprising providing simulation-based scenarios as input for an improvement of the machine learning model.

8. The method according to claim 1, further comprising providing an input data field for reviewing and/or manipulating of explanations as provided for the presented predicted anomalies.

9. The method according to claim 1, further comprising providing a machine learning model based on a set of data of an user input.

10. The method according to claim 1, further comprising providing an input data field for annotating end-user feedback scenarios for machine learning model integration.

11. The method according to claim 1, further comprising allowing a user to search and replay historical scenarios of the machine learning model.
